(19) United States
(12) Patent Application Publication
(10) Pub. No.: US 2014/0308540 A1
(43) Pub. Date: Oct. 16, 2014

(54) PLATED CONTACT AND PROCESS OF MANUFACTURING PLATED CONTACT

(71) Applicant: TYCO ELECTRONICS CORPORATION, Berwyn, PA (US)

(72) Inventor: George Jyh-Shann CHOU, Mechanicsburg, PA (US)

(73) Assignee: TYCO ELECTRONICS CORPORATION, Berwyn, PA (US)

(21) Appl. No.: 13/861,733

(22) Filed: Apr. 12, 2013

(51) Int. Cl. H01R 13/03

(52) U.S. Cl. CPC H01R 13/03
USPC 428/647; 428/648; 427/125; 427/124

(57) ABSTRACT

Plated contacts and processes of manufacturing plated contacts are disclosed. The processes include providing a metallic substrate, applying tin-containing plating over the metallic substrate, applying corrosion-prevention plating over the first tin-containing plating, applying a second tin-containing plating over the first corrosion-prevention plating, applying a second corrosion-prevention plating over the second tin-containing plating, and applying a gold plating over the second corrosion-prevention plating to form the plated contact. One or both of the first corrosion-prevention plating and the second corrosion-prevention plating includes nickel, a nickel-based alloy, copper, a copper containing alloy, or a combination thereof. The plated contacts include a metallic substrate, a first tin-containing plating over the metallic substrate, a first corrosion-prevention plating over the first tin-containing plating, a second tin-containing plating over the first corrosion-prevention plating, a second corrosion-prevention plating over the second tin-containing plating, and a gold plating over the second corrosion-prevention plating to form the plated contact.

### FIELD OF THE INVENTION

The present invention is directed to plated contacts and processes of manufacturing plated contacts. More particularly, the present invention is directed to plated contacts having two or more tin-containing seal platings.

### BACKGROUND OF THE INVENTION

Electrical conductors are utilized in various applications from transmitting data signals to providing a connection across which electrical current may flow. Contacts between two transmitters of electrical current or data signals allow the electrical current or data signals to be transmitted from one conductor to another.

Prior art connectors have included nickel-gold-plated copper conductors. However, pitting corrosion has occurred in such constructions that have resulted in the deterioration of the contacts, which in turn has adversely affected electrical performance. While nickel-based layers (for example, including nickel or nickel alloys, such as, NiP, NiW, and NiPd) have been used as a buffer layer between the outer gold-plating layer and the copper substrate, pitting corrosion occurs through the nickel-gold layer due to pin holes extending through the gold-plating layer and nickel-based layer. Such pin-holes are especially prevalent when using certain application technologies on thin layers, for example, physical vapor deposition.

One solution to the pitting problem has been to apply a seal-plating layer between the nickel layer and the copper layer. The seal-plating layer preferably has been tin-containing (Sn) applied over the copper substrate and in contact with the nickel (Ni) plating layer. After application, the Sn forms an intermetallic with Cu as well as with Ni at its interface with each of these materials. The intermetallic layers are formed either as a result of solid state interdiffusion, which may occur either at room temperature or as a result of an elevated temperature heat treatment, or as a result of Sn reflow. Intermetallic materials are very corrosion resistant, but are also significantly harder and less ductile than the copper substrate over which the Sn is applied, or the Ni or nickel alloys applied over the Sn. The thickness of the intermetallic materials formed by heat treatment or Sn reflow creates an intermetallic layer that is also brittle. Thus, while this solution has solved the problem of pitting, delamination occurs at the thick and brittle intermetallic layer between Ni and Sn, and from the readily formed thin Sn oxide layer from the exposure of Sn to the atmosphere between the Sn and Ni plating operations.

A solution to both the delamination problem and to the pitting problem created by the use of Au/Ni applied over copper substrates or Au/Ni/Sn applied over copper substrates has been achieved by using vapor phase reflow. However, the solution can result in coalescing of pores within the Sn, which can be detrimental to corrosion resistance.

A plated contact and a process of manufacturing a plated contact that do not suffer from one or more of the above drawbacks would be desirable in the art.

### BRIEF DESCRIPTION OF THE INVENTION

In an exemplary embodiment, a process for manufacturing a plated contact includes providing a metallic substrate, applying a first tin-containing plating over the metallic substrate, applying a first corrosion-prevention plating over the first tin-containing plating, applying a second tin-containing plating over the first corrosion-prevention plating, applying a second corrosion-prevention plating over the second tin-containing plating, and applying a gold plating over the second corrosion-prevention plating to form the plated contact. One or both of the first corrosion-prevention plating and the second corrosion-prevention plating includes nickel, a nickel-based alloy, copper, a copper containing alloy, or a combination thereof

In another exemplary embodiment, a process for manufacturing a plated contact includes providing a metallic substrate, applying a first tin-containing plating of about 0.38 micrometers (15×10⁻⁶ inches) to the metallic substrate, rinsing and drying the first tin-containing plating, applying a first corrosion-prevention plating of about 0.5 micrometers (20×10⁻⁶ inches) over the first tin-containing plating, rinsing and drying the first corrosion-prevention plating, applying a second tin-containing plating of about 0.38 micrometers (15×10⁻⁶ inches) to the first corrosion-prevention plating, rinsing and drying the second tin-containing plating, applying a second corrosion-prevention plating of about 0.76 micrometers (30×10⁻⁶ inches) over the second tin-containing plating, rinsing and drying the second corrosion-prevention plating, applying a gold plating over the second corrosion-prevention plating to form the plated contact, and rinsing and drying the plated contact. One or both of the first corrosion-prevention plating and the second corrosion-prevention plating includes nickel, a nickel-based alloy, copper, a copper containing alloy, or a combination thereof.

In another exemplary embodiment, a plated contact includes a metallic substrate, a first tin-containing plating over the metallic substrate, a first corrosion-prevention plating over the first tin-containing plating, a second tin-containing plating over the first corrosion-prevention plating, a second corrosion-prevention plating over the second tin-containing plating, and a gold plating over the second corrosion-prevention plating to form the plated contact. One or both of the first corrosion-prevention plating and the second corrosion-prevention plating includes nickel, a nickel-based alloy, copper, a copper containing alloy, or a combination thereof.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a flow diagram of a process of manufacturing a plated contact, according to an embodiment of the disclosure.

FIG. 2 is a schematic view of layers within a plated contact, according to an embodiment of the disclosure, with the plated contact not being treated by vapor phase reflow.

FIG. 3 is a schematic view of layers within a plated contact, according to an embodiment of the disclosure, with the plated contact being treated by vapor phase reflow.

Wherever possible, the same reference numbers will be used throughout the drawings to represent the same parts.

### DETAILED DESCRIPTION OF THE INVENTION

Provided is an exemplary plated contact and a process of manufacturing a plated contact. Embodiments of the present disclosure, for example, in comparison to plated contacts and processes of manufacturing plated contacts that do not include one or more of the features disclosed herein, reduce or eliminate corrosion, reduce or eliminate delamination, reduce or eliminate coalescing of pores within one or more tin-containing seals, permit soldering of nickel to copper since tin-containing is used as a solder to join nickel and copper, convert at least a portion of tin-containing present into tin-containing intermetallics, permit more coating application technologies to be used to apply thinner layers (for example, physical vapor deposition), disrupt formation and/or alignment of through-holes in Au/Ni/Sn layer arrangements, or a combination thereof.

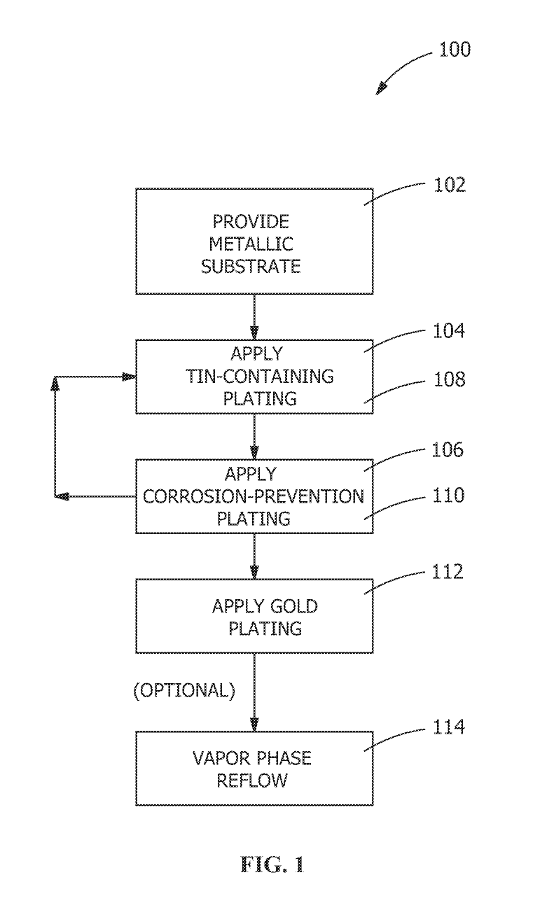

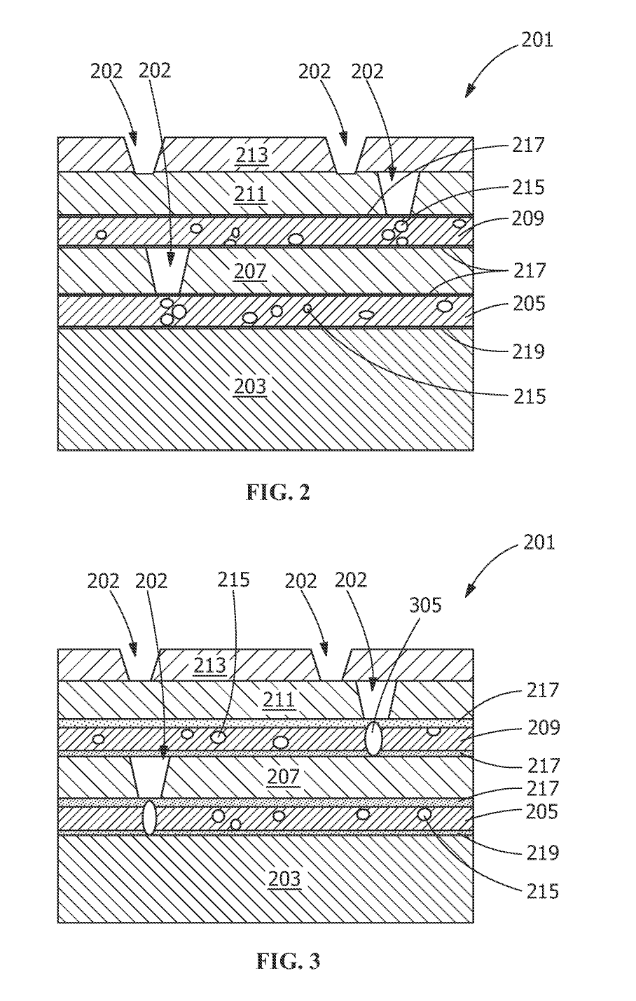

FIG. 1 depicts a process 100 for manufacturing a plated contact 201, as is shown in FIG. 2 or FIG. 3. The plated contact 201 includes a metallic substrate 203 (for example, copper or a copper-based alloy), a first tin-containing plating 205 over the metallic substrate 203, a first corrosion-prevention plating 207 over the first tin-containing plating 205, a second tin-containing plating 209 over the first corrosion-prevention plating 207, a second corrosion-prevention plating 211 over the second tin-containing plating 209, and a gold plating 213 over the second corrosion-prevention plating 211. The first corrosion-prevention plating 207 and/or the second corrosion-prevention plating 211 include nickel (for example, from nickel sulfamate), a nickel-based alloy (such as, NiP, NiW, or NiPd), a copper-containing alloy, and/or copper.

The process 100 includes providing the metallic substrate 203 (step 102), applying the first tin-containing plating 205 over the metallic substrate 203 (step 104), applying the first corrosion-prevention plating 207 over the first tin-containing plating 205 (step 106), applying a second tin-containing plating 209 over the first corrosion-prevention plating 207 (step 108), applying the second corrosion-prevention plating 211 over the second tin-containing plating 209 (step 110) and applying the gold plating 213 over the second corrosion-prevention plating 211 to form the plated contact 201 (step 112). In one embodiment, these platings and/or other platings applied according to the disclosure are rinsed and/or dried as part of the process 100, for example, with or without activation of the tin-containing plating 205.

In further embodiments, additional layers are applied to the plated contact 201. For example, in one embodiment, the plated contact 201 further includes a third tin-containing plating (not shown) over the second corrosion-prevention plating 211, and a third corrosion-prevention plating (not shown) over the third tin-containing plating. In yet a further embodiment, a fourth tin-containing plating (not shown) is over the third corrosion-prevention plating and a fourth corrosion-prevention plating (not shown) is over the fourth tin-containing plating. As will be appreciated, any suitable number of the corrosion-prevention platings and the tin-containing platings are capable of being included to provide a desired amount of corrosion resistance, resistance to delamination, and/or other properties.

The platings include any suitable thicknesses capable of providing desired properties, for example, desirably balancing Ni with Sn or Cu to convert all Ni to intermetallics and/or being at a reduced thickness to decrease costs. The first tin-containing plating 205 has a first thickness and the second tin-containing plating 209 has a second thickness, the first thickness differing from the second thickness or the first thickness being equal to the second thickness. Suitable ranges of thicknesses for the first tin-containing plating 205 and/or the second tin-containing plating 209 include, but are not limited to, between about 0.25 micrometers (10×10⁻⁶ inches) and about 1 micrometer (40×10⁻⁶ inches), between about 0.38 micrometers (15×10⁻⁶ inches) and about 1 micrometer (40×10⁻⁶ inches), between about 0.25 micrometers (10×10⁻⁶ inches) and about 0.76 micrometers (30×10⁻⁶ inches), between about 0.38 micrometers (15×10⁻⁶ inches) and about 0.76 micrometers (30×10⁻⁶ inches), or any suitable combination, sub-combination, range, or sub-range therein.

The first corrosion-prevention plating 207 has a first thickness and the second corrosion-prevention plating 211 has a second thickness, the first thickness differing from the second thickness or being equal to the second thickness. Suitable ranges of thicknesses for the first corrosion-prevention plating 207 and/or the second corrosion-prevention plating 211 include, but are not limited to, between about 0.25 micrometers (10×10⁻⁶ inches) and about 1.52 micrometers (60×10⁻⁶ inches), between about 0.5 micrometers (20×10⁻⁶ inches) and about 1.52 micrometers (60×10⁻⁶ inches), between about 0.5 micrometers (20×10⁻⁶ inches) and about 1.27 micrometers (50×10⁻⁶ inches), between about 0.5 micrometers (20×10⁻⁶ inches) and about 0.76 micrometers (30×10⁻⁶ inches), between about 0.76 micrometers (30×10⁻⁶ inches) and about 1.52 micrometers (60×10⁻⁶ inches), between about 0.76 micrometers (30×10⁻⁶ inches) and about 1.27 micrometers (50×10⁻⁶ inches), between about 1.27 micrometers (50×10⁻⁶ inches) and about 1.52 micrometers (60×10⁻⁶ inches), or any suitable combination, sub-combination, range, or sub-range therein.

In one embodiment, the gold plating 213 has a thickness, for example, between about 0.025 micrometers (1×10⁻⁶ inches) and about 1.27 micrometers (50×10⁻⁶ inches), between about 0.025 micrometers (1×10⁻⁶ inches) and about 0.76 micrometers (30×10⁻⁶ inches), between about 0.025 micrometers (1×10⁻⁶ inches) and about 0.38 micrometers (15×10⁻⁶ inches), between about 0.025 micrometers (1×10⁻⁶ inches) and about 0.25 micrometers (10×10⁻⁶ inches), between about 0.025 micrometers (1×10⁻⁶ inches) and about 0.13 micrometers (5×10⁻⁶ inches), between about 0.13 micrometers (5×10⁻⁶ inches) and about 0.38 micrometers (15×10⁻⁶ inches), between about 0.13 micrometers (5×10⁻⁶ inches) and about 0.25 micrometers (10×10⁻⁶ inches), between about 0.25 micrometers (10×10⁻⁶ inches) and about 0.38 micrometers (15×10⁻⁶ inches), about 0.76 micrometers (30×10⁻⁶ inches), about 1.27 micrometers (50×10⁻⁶ inches), greater than about 1.27 micrometers (50×10⁻⁶ inches), or any suitable combination, sub-combination, range, or sub-range therein.

As shown in FIGS. 2 and 3, the first tin-containing plating 205 (a tin-containing seal) and/or the second tin-containing plating 209 (also a tin-containing seal) include(s) one or more pores 215. The pores 215 are capable of decreasing corrosion protection of the tin-containing seal when aligned with pin holes 202. For example, the pores 215 and the pin holes 202 can form a continuous through-thickness passage for corrosion media in the environment. The corrosion media can pass through the passage, permitting corrosive attack of lower layers. Isolation of the pores 215 and/or reducing or eliminating alignment of the pores 215 increases corrosion resistance. As shown in FIG. 2, in one embodiment, the pores 215 in the plated contact 201 are isolated and have not coalesced, for example, as can occur through vapor phase reflow. As shown in FIG. 3, in one embodiment, one of more of the pores 215 is a coalesced pore 305 in the plated contact 201 formed through coalescing, for example, from vapor melt reflow. In one embodiment, the first tin-containing plating 205 and the second tin-containing plating 209 include fewer of the pores 215 being coalesced than a single tin-containing plating (not shown) having the same thickness as the combined thickness of the first tin-containing plating 205 and the second tin-containing plating 209. In one embodiment, few or no pores extend through more than one plating layer and are, thus, isolated.

As shown in FIG. 2, in one embodiment, the plated contact 201 is not treated by vapor phase reflow and/or is devoid of expanded intermetallic lamina formed by vapor phase reflow, for example, having one or more Ni/Sn intermetallic laminae 217 and/or a Sn/Cu intermetallic lamina 219 that has not been expanded in thickness.

Alternatively, as shown in FIG. 3, in one embodiment, the plated contact 201 is treated by vapor phase reflow (step 114) and/or includes the Ni/Sn intermetallic lamina(e) 217 being expanded in thickness, at least in part, by the vapor phase reflow (step 114), as is further described below. In addition to or alternative to vapor phase reflow (step 114), infrared heating and/or other reflow heating is capable of being used. The vapor phase reflow (step 114) forms the Ni/Sn intermetallic laminae 217, having primarily Ni₃Sn₄ intermetallics, and to a lesser extent Ni₃Sn and Ni₃Sn₂ intermetallics at the Ni/Sn interface. In one embodiment, the Ni/Sn intermetallic laminae 217 has a thickness of about 0.01 micrometers (about 4×10⁻⁷ inches). The interdiffusion of Ni and Sn forms Ni₃Sn₄, but other intermetallics, such as Ni₃Sn₂, are capable of being formed in Ni-rich areas. Additionally or alternatively, the Sn/Cu intermetallic lamina 219 is treated and expanded in thickness. In this embodiment, the Sn/Cu intermetallic lamina 219 primarily includes Cu₆Sn₅ intermetallic, and to a lesser extent Cu₃Sn at the Sn/Cu interface. In one embodiment, the Sn/Cu intermetallic lamina 219 has a thickness of about 0.05 micrometers (about 2×10⁻⁶ inches). The interdiffusion of Cu and Sn forms Cu₆Sn₅, with the possible formation of Cu₃Sn in Cu-rich areas. After completion of the vapor phase reflow (step 114), a substantial portion of Sn remains. In one embodiment, the Sn in the second tin-containing plating 209 and/or the Sn/Cu intermetallic lamina 219 fully convert(s) to Ni/Sn and Ni/Cu intermetallics, for example, in response to an extended duration of the vapor phase reflow (step 114).

The vapor phase reflow (step 114) involves heating a component above its melting temperature using a fluid having a known vaporization temperature above the melting temperature of the component. In one embodiment, the process 100 includes the vapor phase reflow (step 114), for example, heating Sn above its melting temperature. The vaporization of the fluid is at a substantially uniform temperature that is very difficult to exceed. The vapor phase reflow operation itself involves vaporization of a fluid. The vapor phase is inert and is capable of being done oxygen-free, when the enclosure containing the vapor phase is properly designed to contain the vapor while sealing out oxygen. The oxygen is capable of being removed by introduction of a non-oxidizing gas to displace the oxygen or by pulling vacuum prior to introduction of the vapor phase. This also delivers a consistent heating across the plated contact 201, while limiting absolute maximum temperature. Any suitable vapor phase reflow fluid is utilized, for example, perfluorinated fluids that are non-corrosive, are non-flammable, are non-toxic, and/or leave no residue after evaporation. Suitable perfluorinated fluids include, but are not limited to, HS/240 and HS/260 perfluoropolyether (PFPE) fluids (available from Solvay Solexis, Anaheim, Calif.), with 240 and 260 referring to the targeted reflow temperatures of each respective fluid: 240° C. (464° F.) and 260° C. (500° F.).

The vapor phase reflow (step 114) transfers heat faster than other heating processes, such as infrared and convection oven heating, even in controlled atmospheres. As a result, the plated contact 201 is capable of being heated to a uniform temperature for a short period of time, while obtaining uniform heating across the contact.

The process 100 is capable of being adapted to continuous processing. For example, in one embodiment, the metallic substrate 203 is provided on reels (not shown) and the reels are processed continuously through various baths (not shown) prior to being sent through the vapor phase reflow (step 114). After the vapor phase reflow (step 114), the plated contacts 201 are then processed onto a reel for further processing.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for manufacturing a plated contact, the process comprising:
providing a metallic substrate;
applying a first tin-containing plating over the metallic substrate;
applying a first corrosion-prevention plating over the first tin-containing plating;
applying a second tin-containing plating over the first corrosion-prevention plating;
applying a second corrosion-prevention plating over the second tin-containing plating; and
applying a gold plating over the second corrosion-prevention plating to form the plated contact;
wherein one or both of the first corrosion-prevention plating and the second corrosion-prevention plating includes nickel, a nickel-based alloy, copper, a copper containing alloy, or a combination thereof.

2. The process of claim 1, further comprising:
applying a third tin-containing plating over the second corrosion-prevention plating; and
applying a third corrosion-prevention plating over the third tin-containing plating.

3. The process of claim 2, further comprising:
applying a fourth tin-containing plating over the third corrosion-prevention plating; and
applying a fourth corrosion-prevention plating over the fourth tin-containing plating.

4. The process of claim 1, wherein the first tin-containing plating has a first thickness and the second tin-containing plating has a second thickness, the first thickness differing from the second thickness.

5. The process of claim 1, wherein the first tin-containing plating has a first thickness and the second tin-containing plating has a second thickness, the first thickness being equal to the second thickness.

6. The process of claim 1, wherein the first corrosion-prevention plating has a first thickness and the second corrosion-prevention plating has a second thickness, the first thickness differing from the second thickness.

7. The process of claim 1, wherein the first corrosion-prevention plating has a first thickness and the second corrosion-prevention plating has a second thickness, the first thickness being equal to the second thickness.

8. The process of claim 1, wherein the first tin-containing plating has a thickness of between about 0.25 micrometers (10×10⁻⁶ inches) and about 1 micrometer (40×10⁻⁶ inches).

9. The process of claim 1, wherein the second tin-containing plating has a thickness of between about 0.25 micrometers (10×10⁻⁶ inches) and about 1 micrometer (40×10⁻⁶ inches).

10. The process of claim 1, wherein the first tin-containing plating has a thickness of about 0.38 micrometers (15×10⁻⁶ inches) and the second tin-containing plating has a thickness of about 0.38 micrometers (15×10⁻⁶ inches).

11. The process of claim 1, wherein the first corrosion-prevention plating has a thickness of between about 0.25 micrometers (10×10⁻⁶ inches) and about 1.52 micrometers (60×10⁻⁶ inches).

12. The process of claim 1, wherein the second corrosion-prevention plating has a thickness of between about 0.25 micrometers (10×10⁻⁶ inches) and about 1.52 micrometers (60×10⁻⁶ inches).

13. The process of claim 1, wherein the first corrosion-prevention plating has a thickness of about 0.5 micrometers (20×10⁻⁶ inches) and the second corrosion-prevention plating has a thickness of about 0.76 micrometers (30×10⁻⁶ inches).

14. The process of claim 1, wherein the gold plating has a thickness of about 0.38 micrometers (15×10⁻⁶ inches).

15. The process of claim 1, wherein the metallic substrate is a copper substrate.

16. The process of claim 1, further comprising vapor phase reflowing to form a first intermetallic lamina between the first tin-containing plating and the first corrosion-prevention plating and a second intermetallic lamina between the second tin-containing plating and the second corrosion-prevention plating.

17. The process of claim 1, further comprising applying a copper strike layer prior to applying the first corrosion-prevention plating.

18. The process of claim 1, wherein the first tin-containing plating and the second tin-containing plating include fewer coalesced pores than a single tin-containing plating having the same thickness as the combined thickness of the first tin-containing plating and the second tin-containing plating.

19. A process for manufacturing a plated contact, the process comprising:
providing a metallic substrate;
applying a first tin-containing plating of about 0.38 micrometers (15×10⁻⁶ inches) over the metallic substrate;
rinsing and drying the first tin-containing plating;
applying a first corrosion-prevention plating of about 0.5 micrometers (20×10⁻⁶ inches) over the first tin-containing plating;
rinsing and drying the first corrosion-prevention plating;
applying a second tin-containing plating of about 0.38 micrometers (15×10⁻⁶ inches) over the first corrosion-prevention plating;
rinsing and drying the second tin-containing plating;
applying a second corrosion-prevention plating of about 0.76 micrometers (30×10⁻⁶ inches) over the second tin-containing plating;
rinsing and drying the second corrosion-prevention plating;
applying a gold plating over the second corrosion-prevention plating to form the plated contact; and
rinsing and drying the plated contact;
wherein one or both of the first corrosion-prevention plating and the second corrosion-prevention plating includes nickel, a nickel-based alloy, copper, a copper containing alloy, or a combination thereof.

20. A plated contact, comprising:
a metallic substrate;
a first tin-containing plating over the metallic substrate;
a first corrosion-prevention plating over the first tin-containing plating;
a second tin-containing plating over the first corrosion-prevention plating;
a second corrosion-prevention plating over the second tin-containing plating; and
a gold plating over the second corrosion-prevention plating to form the plated contact;
wherein one or both of the first corrosion-prevention plating and the second corrosion-prevention plating includes nickel, a nickel-based alloy, copper, a copper containing alloy, or a combination thereof.
